(19) United States
(12) Patent Application Publication
(10) Pub. No.: US 2022/0145092 A1
(43) Pub. Date: May 12, 2022

(54) BIT COMPOSITIONS WITH SIGNIFICANTLY IMPROVED ACTIVITY

(71) Applicant: Troy Technology II, Inc., Florham Park, NJ (US)

(72) Inventors: Jake Zachary Jacobs, Morris Plains, NJ (US); Meihua Yang, Hillsborough, NJ (US)

(73) Assignee: Troy Technology II, Inc., Florham Park, NJ (US)

(21) Appl. No.: 17/522,314

(22) Filed: Nov. 9, 2021

Related U.S. Application Data
(60) Provisional application No. 63/111,937, filed on Nov. 10, 2020.

(51) Int. Cl. C09D 5/02; C09D 7/63; C09D 5/14

(52) U.S. Cl. CPC C09D 5/025; C09D 5/14; C09D 7/63

(57) ABSTRACT

A preservative composition comprising an isothiazolinone, such as 1,2-benzisothiazolin-3-one, and a polyethertriamine in a synergistic combination. The polyethertriamine enhances the antimicrobial activity of the isothiazolinone, achieving the desired antimicrobial activity at synergistically lower concentrations than with the isothiazolinone in the absence of the polyethertriamine. Also, methods of using the preservative compositions to provide wet-state preservation of industrial materials including paints, coatings, and metal working fluids.

### CROSS-REFERENCE TO RELATED APPLICATIONS

This is a U.S. non-provisional application filed under 35 U.S.C. § 111(a), claiming priority under 35 U.S.C. § 120 of U.S. Provisional Application No. 63/111,937, filed Nov. 10, 2020, the entire contents of which are incorporated herein by reference for all purposes.

### BACKGROUND OF THE INVENTION

1,2-benzisothiazolin-3-one (also referred to as “BIT”) is known to be an effective bactericide in a variety of applications. BIT is currently one of the few remaining broadly effective formaldehyde-free preservatives that is stable at higher pH and effective as a long-term preservative.

While BIT has proven useful in a wide range of applications, it also has notable weaknesses. Specifically, BIT is a slow-acting preservative that has an unbalanced efficacy spectrum, particularly against some Pseudomonas species that are common to industrial spoilage. For this reason, effective preservation often requires blending BIT with additional biocidal ingredients to acceptable levels of preservation, but higher levels are limited by regulatory limits and required labeling. In Europe, products protected with >50 ppm BIT trigger the GHS statement “EUH208” and products protected with >500 ppm BIT require classification and H317 labeling as “Skin Sens; May cause an allergic skin reaction.”

Given that these labels are undesirable to formulations and that BIT is not consistently effective below 500 ppm, and is especially not typically effective below 50 ppm, a synergistic and broadly effective BIT-based product is desired.

### SUMMARY OF THE INVENTION

The present inventors have discovered that polyethertriamine synergy with BIT differentiates significantly from other amine and BIT combinations. This specific synergy of polyethertriamine and BIT is particularly useful for industrial protection of paints and colorants, providing equal protection to paints and colorants with significantly lower BIT concentrations over standard BIT products now used for wet state preservation.

In one aspect, the present invention relates to a preservative composition comprising (a) 1,2 benzisothiazolin-3-one and (b) at least one compound of the formula I:

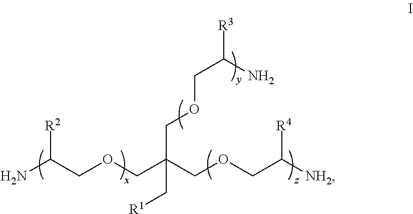

wherein R¹ is H or C₁ to C₉ alkyl, R², R³, and R⁴ are independently H or CH₃, and x, y, and z are independently 1 to 10, and wherein (a) and (b) are present in a weight ratio (a):(b) of from 1:200 to 2:3. 1,2-benzisothiazolin-3-one is known also, and will be referred to herein, as “BIT”.

In another aspect, the present invention relates to a preservative concentrate comprising the preservative composition comprising (a) 1,2 benzisothiazolin-3-one and (b) at least one compound of the formula I, wherein the concentrate comprises 1 to 45% w/w of (a), based on the weight of the concentrate.

In another aspect, the present invention relates to an industrial material comprising a preservative, the preservative comprising a combination of (a) 1,2 benzisothiazolin-3-one and (b) at least one compound of the formula I, wherein (a) and (b) are present in a weight ratio (a):(b) of from 1:200 to 2:3, and wherein (a) is present in the industrial material in a total amount of less than or equal to about 500 ppm.

In a further aspect, the present invention relates to a method of preserving an industrial material in the wet state, comprising adding to the industrial material an effective amount of a preservative that comprises (a) 1,2 benzisothiazolin-3-one and (b) a polyethertriamine of the formula I:

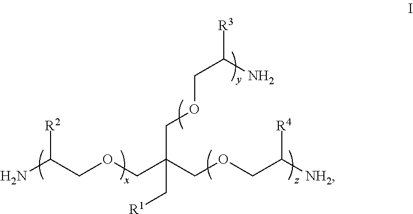

wherein R¹ is H or C₁ to C₉ alkyl, R², R³, and R⁴ are independently H or CH₃, and x, y, and z are independently 1 to 10, and wherein (a) and (b) are present in a weight ratio (a):(b) of from 1:200 to 2:3.

These and other aspects will become apparent upon reading the following detailed description of the invention.

### BRIEF DESCRIPTION OF THE DRAWINGS

FIG. 1 plots minimum inhibitory concentration (MIC) against P. aeruginosa and calculated synergy index (SI) for blends of BIT and polyethertriamine.

### DETAILED DESCRIPTION OF THE INVENTION

It has now been surprisingly found in accordance with the present invention that a preservative composition containing 1,2-benzisothiazolin-3-one in combination with a polyethertriamine exhibits synergistic antimicrobial efficacy, as compared to BIT-containing compositions that do not contain the polyethertriamine.

Preservative compositions according to the present invention comprise (a) 1,2 benzisothiazolin-3-one and (b) at least one compound of the formula I:

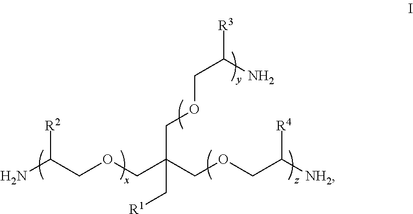

wherein R¹ is H or C₁ to C₉ alkyl, R², R³, and R⁴ are independently H or CH₃, and x, y, and z are independently 1 to 10, and wherein (a) and (b) are present in a weight ratio (a):(b) of from 1:200 to 2:3. In a preferred aspect of the invention, x, y, and z are independently 1 to 5. In another preferred aspect of the invention, x, y, and z are independently 1, 2, or 3. In a further preferred aspect of the invention, x, y, and z, are independently 1, 2, or 3, and x+y+z≥5 or 6. A preferred polyethertriamine of the formula I is Jeffamine® T403 polyetheramine from Huntsman.

In preferred embodiments of the present invention, (a) and (b) may be present in a weight ratio (a):(b) of from 1:160 or 1:150 or 1:125 or 1:100 or 1:75 or 1:50 to 1:2, or in a weight ratio (a):(b) of from 1:25 to 1:3. In other embodiments of the invention, (a) and (b) may be present in a weight ratio (a):(b) of from 5:95 to 33:67, or of from 1:40 to 1:2, 1:30 to 1:2, 1:20 to 1:2, or 1:20 to 1:3. Preservative compositions according to the invention may also comprise (a) and (b) in a weight ratio (a):(b) defined by any combination of the foregoing ratios.

The preservative composition according to the present invention may suitably be formulated as a preservative concentrate, wherein the concentrate comprises 1 to 45% w/w of (a), based on the weight of the concentrate. The concentrate may also be formulated to contain 1 to 40% w/w, 3 to 40% w/w, 5 to 40% w/w, 5 to 35% w/w, 5 to 30% w/w, 10 to 25% w/w, 15 to 25% w/w, or 20 to 25% w/w of (a). Concentrates within the scope of the invention may be formulated to contain (a) within any range defined by any combination of values given as upper or lower limits of the foregoing ranges, e.g. 1 to 15% w/w, 3 to 10% w/w, 20 to 45% w/w, etc.

The preservative composition may further comprise one or more co-biocides, for example one or more fungicides, bactericides, or algaecides, wherein the concentrate comprises 1 to 50% w/w of the co-biocide, based on the weight of the concentrate. Suitable co-biocides include fungicides like propiconazole, IPBC, sodium pyrithione, zinc pyrithione, OIT, and related compounds to close fungal efficacy gaps that could exist for certain end-uses.

The preservative compositions may contain one or more additives. Suitable additives include water, surfactants, emulsifiers, acidifiers, dispersants, stabilizers, buffers, pH regulators, organic solvents, dyes, fragrances, and pigments. A typical formulation minimally will contain, in addition to (a) and (b), water and/or an organic solvent.

The preservative composition may take the form of a solution, with the BIT dissolved in the polyethertriamine. BIT is generally soluble at higher pH, for example pH≥10, and will dissolve readily in the polyethertriamine (e.g., polyetheretriamine T403, pH ˜11.5). In other embodiments, the preservative composition may be formulated as a suspension, emulsion, or dispersion as needed to incorporate partly-soluble or insoluble components including co-biocides. The pH of the preservative composition may be varied from acidic to basic depending on the desired incorporation of one or more components, including the BIT and/or further co-biocides, in solution, emulsion, dispersion, or suspension.

In one embodiment, the BIT is pre-dissolved in caustic or glycol and then the pH is raised with caustic until the BIT forms its water-soluble ammonium salt. In another embodiment, BIT is pre-dissolved in polyethyleneglycol and the pH is raised by addition of the polyethertriamine. With heat it is possible to dissolve BIT powder (85%) in polyethertriamine T403 at lower concentrations. In a further embodiment, the BIT and polyetheramine are dissolved in water or a solution of potassium hydroxide. In all these embodiments, the resulting product is a solution.

The pH of the preservative composition can be lowered to incorporate another pH sensitive component, for example, a co-biocide, e.g., a fungicide, that degrades at the elevated pH necessary to dissolve the BIT in the polyethertriamine. In such formulations, the polyethertriamine could be suspended or dispersed with appropriate surfactants and/or rheology modifiers.

The preservative compositions of the invention are suitably incorporated into industrial materials to impart wet-state preservation. Industrial materials in need of such preservation include paints, colorants, coatings, plasters, adhesives, sealants, caulks, mineral slurries, pigments, pigment slurries, concrete, polymer emulsions, polymer dispersions, inks, sizes, agricultural pesticide formulations, household coating products, personal care products, cooling lubricants, heat transfer liquids, metal working fluids, oil concentrates, varnishes, sealing compositions, leather auxiliaries, paper coating agents, and cosmetics.

Industrial materials according to the invention therefore comprise a preservative, the preservative comprising a combination of (a) at least one isothiazolin-3-one and (b) at least one compound of the formula I:

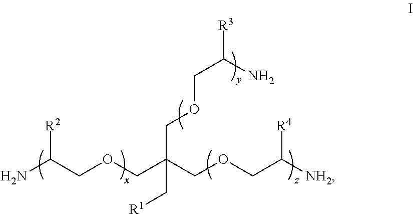

wherein R¹, R², R³, R⁴, x, y, and z are as previously defined, wherein (a) and (b) are present in a weight ratio (a):(b) of from 1:50 to 40:60, and wherein (a) is present in the industrial material in a total amount of less than or equal to about 500 ppm.

In other aspects of the invention, (a) is present in the industrial material in a total amount of less than or equal to 400 ppm, 300 ppm, 200 ppm, or 100 ppm. In further aspects of the invention, (a) is present in the industrial material in a total amount of at least 5 ppm, 10 ppm, 15 ppm, 20 ppm, or 25 ppm. In yet other aspects of the invention, (a) may be present in the industrial material in a total amount of about 5 ppm to about 50 ppm, about 5 ppm to about 40 ppm, about 5 ppm to about 30 ppm, about 10 ppm to about 25 ppm, less than or equal to about 50 ppm, or less than or equal to about 25 ppm. It is further within the scope of the invention that (a) is present in the industrial material within any range defined by any combination of values given as upper or lower limits of the foregoing ranges, e.g. about 5 ppm to about 500 ppm, about 100 ppm to about 500 ppm, about 40 ppm to about 50 ppm, about 5 ppm to about 10 ppm, etc.

The industrial material into which the preservative composition of the present invention is suitably incorporated is preferably a functional fluid. The functional fluid suitably comprises an aqueous base medium plus the preservative of the invention. The preservative can be provided in the form of a concentrate that, upon dilution with water, provides antimicrobial efficacy in the functional fluid.

The preservative compositions of the present invention are suitably used in functional fluids such as polymer emulsions, or other coating compositions, to impart wet state preservation. Polymers useful in polymer emulsions include acrylic and substituted (meth)acrylates, styrene/butadiene, ethylene vinyl acetate, polyvinyl acetate, styrene/butadiene/N-methylol acrylamide, nitrile and copolymers of the aforementioned. Typical functional fluids include coating compositions, such as paints, adhesives, sealants, caulks, mineral and pigment slurries, printing inks, agricultural pesticide formulations, household products, personal care, metal working fluids, and other aqueous based systems.

The industrial material may further comprise one or more co-biocides selected from the group consisting of fungicides, bactericides, and algaecides, wherein the co-biocide is present in the industrial material in an amount of from about 0.001 to about 1.0% w/w based on the total weight of the industrial material.

The invention further relates to a method of preserving an industrial material in the wet state, comprising adding to the industrial material an effective amount of a preservative, the preservative comprising a combination of (a) at least one isothiazolin-3-one and (b) at least one compound of the formula I:

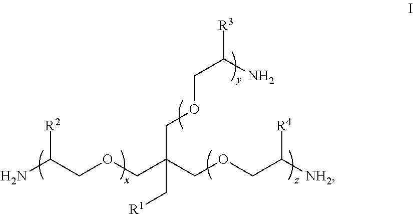

wherein R¹, R², R³, R⁴, x, y, and z are as previously defined, wherein (a) and (b) are present in a weight ratio (a):(b) of from 1:50 to 40:60.

In one aspect of the method according to the invention, the preservative composition is added to the industrial material such that (a) is present in the industrial material in a total amount of less than or equal to about 500 ppm. In other aspects of the invention, the preservative composition is added to the industrial material such that (a) is present in the industrial material in a total amount of less than or equal to 400 ppm, 300 ppm, 200 ppm, or 100 ppm. In yet other aspects of the invention, (a) may be present in the industrial material in a total amount of about 5 ppm to about 50 ppm, about 5 ppm to about 40 ppm, about 5 ppm to about 30 ppm, about 10 ppm to about 25 ppm, less than or equal to about 50 ppm, or less than or equal to about 25 ppm. It is further within the scope of the invention that the preservative composition is added to the industrial material such that (a) is present in the industrial material within any range defined by any combination of values given as upper or lower limits of the foregoing ranges, e.g. about 5 ppm to about 500 ppm, about 100 ppm to about 500 ppm, about 40 ppm to about 50 ppm, about 5 ppm to about 10 ppm, etc.

The method of preserving an industrial material according to the invention may comprise inhibiting or preventing growth of microorganisms in the industrial material. The microorganisms to be inhibited or prevented from growing include bacteria, fungi, yeasts, algae, slimes, and mixtures or combinations thereof.

The invention is further described in the Examples given below. All percentages given herein are weight percents based on the total weight of the composition, unless otherwise stated. All patents referred to in this application are incorporated herein by reference in their entirety.

### EXAMPLES

### Experimental Methods

### Minimum Inhibitory Concentration Testing

MICs were determined via microbroth dilution using the following specific test parameters:

| | |
|---|---|
| Format | 96-well plate |
| Strength | ~1.0*10⁵ CFU/mL |
| Standardization | OD₆₀₀ |
| Incubation Temperature | 35° C. |
| Incubation Time | 2 days |
| Test Endpoint | No growth (via turbidity) |
| Test Media | Mueller Hinton Broth (MHB) |

Necessary organism dilutions via OD₆₀₀ were calculated based on OD₆₀₀ of 1.0 being equivalent to 8*10⁸ CFU/mL. Biocide dilutions were performed in 2-fold increments for each assay.

### Synergy Index Calculations

Synergy index (SI) scores were calculated according to the mass action equation below:

S.I.=[MIC[A] in-blend/MIC[A] alone]+[MIC[B] in-blend/MIC[B] alone]

Combinations of ingredients were determined to be synergistic (S.I.≤0.5), additive (S.I.>0.5 to 1), indifferent (S.I.>1 to <2) or antagonistic (S.I.≥2), as defined by EUCAST guidelines¹. 1 European Committee for Antimicrobial Susceptibility Testing (EUCAST) of the European Society of Clinical Microbiology and Infectious Diseases (ESCMID). EUCAST Definitive Document E.Def 1.2, May 2000: Terminology relating to methods for the determination of susceptibility of bacteria to antimicrobial agents. Clin. Microbiol. Infect. Off. Publ. Eur. Soc. Clin. Microbiol. Infect. Dis. 6, 503-508 (2000).

### Bacterial Challenge Testing (Industrial Strength)

Where industrial strength inoculations are indicated, bacterial challenge testing organisms were Alcaligenes faecalis (ATCC #25094), Enterobacter aerogenes (ATCC #13048), Escherichia coli (ATCC #11229), Pseudomonas aeruginosa (ATCC #10145), Staphylococcus aureus (ATCC #6538), Microbacterium paraoxydans (Troy Isolate), Burkholderia cenocepacia (Troy Isolate), Citrobacter werkmanii (Troy Isolate), and Acinetobacter sp. (Troy Isolate). All bacteria were blended from separate overnight cultures grown in Tryptic Soy Broth (TSB) and mixed at equal CFU via OD₆₀₀ measurements, then diluted to OD₆₀₀=7 (˜10⁹ CFU/mL) to create the final bacterial consortium. Each mixture was prepared shortly before each inoculation. Inoculations were performed by adding 0.1 mL to 50 g of the indicated test sample to give ˜10⁷ CFU/g per inoculation. Viability readings were performed at the indicated intervals following each challenge by applying a small amount of the test sample onto PCA. Plates were then incubated at 32° C. for 3-5 days before being evaluated with a semi-quantitative scale. This scale estimates the approximate CFU/g by visual assessment of the colony density along the streak lines. Readings are recorded as the average of two duplicate semi-quantitative readings from “0” to “4.” Samples were mixed before every viability reading and after every inoculation.

| Colony Count | Rating | Approximate CFU/g |
|---|---|---|
| 0 | 0 | <1 |
| 1-10 | 1 | 10-10² |
| 11-100 | 2 | 10³-10⁴ |
| 101-1000 | 3 | 10⁴-10⁵ |
| >1000 | 4 | >10⁵ |

### Test Biocide Composition

### Ref—“1721-88”

| Chemical Name | Percentage | CAS# |
|---|---|---|
| Jeffamine T403 | 50% | — |
| Mergal BIT (84.5%) | 11.83% | 2634-33-5 |
| Polyglycol P1000 (Dow) | 38.17% | 25322-69-4 |

### Commercial Product Compositions

| Product | Active Content | Carrier |
|---|---|---|
| Mergal BIT20X | 20% BIT | Glycolic |
| | | solution |
| Mergal K10N | 10% BIT | Water |

### Unpreserved Matrices

Unpreserved test matrices of paint and colorant were obtained from the following Troy projects:

| Troy Code | Sample Type |
|---|---|
| U19-0785-4 | Interior Paint #1 |
| U20-0586-1 | Colorant (Black) |
| U20-0586-2 | Colorant (Red) |

### Example 1

MIC values for Mergal BIT20X (20% BIT), individual amines, and 1:1 mixtures of amines and Mergal BIT20X were determined against the test organism Pseudomonas aeruginosa (ATCC 10145) using 96-well microbroth dilution methodology. The MIC values are reported in Table 1 on product level. All amines except the two tested polyethertriamines (MW703, T403) showed additive behavior with Mergal BIT20X; the polyethertriamines showed highly synergistic behavior with BIT20X.

TABLE 1

| | Pseudomonas aeruginosa (ATCC #10145) MIC, ppm | | | | | | |
|---|---|---|---|---|---|---|---|
| | Mergal BIT20X + Amine (1:1) | | | Amine Only | | | |
| Tested Amine | Rep. 1 | Rep. 2 | Avg. | Rep. 1 | Rep.2 | Avg. | Synergy Index |
| None (BIT20X) | 78 | 156 | 117 | — | — | — | |
| TETA | 156 | 156 | 156 | 625 | 1250 | 938 | 0.75 |
| Jeffadd MW781 | 156 | 313 | 234 | 1250 | 1250 | 1250 | 1.09 |
| Jeffadd MW740 | 156 | 156 | 156 | 2500 | 2500 | 2500 | 0.70 |
| Jeffadd MW750 | 313 | 156 | 234 | 2500 | 2500 | 2500 | 1.05 |
| Jeffadd MW703 | 39 | 20 | 29 | 2500 | 1250 | 1875 | 0.13 |
| Dytek A | 313 | 313 | 313 | 2500 | 2500 | 2500 | 1.40 |
| Jeffamine ED600 | 156 | 156 | 156 | >5000 | >5000 | >5000 | <0.68 |
| Jeffamine D230 | 313 | 313 | 313 | 5000 | 5000 | 5000 | 1.36 |
| Jeffamine T403 | 78 | 78 | 78 | 2500 | 2500 | 2500 | 0.35 |
| Jeffamine M600 | 313 | 313 | 313 | >5000 | >5000 | >5000 | <1.36 |

### Example 2

The combination of the polyethertriamine Jeffamine® T403 and Mergal® BIT20X is broadly synergistic against diverse bacterial organisms. MIC values of Jeffamine T403, Mergal BIT20X, and a 1:1 mixture were measured against the indicated test organisms; the results are presented in Table 2. The blend of T403 and BIT20X (“1 to 1 Mixture”; containing equal parts of each product by weight %) was synergistic against all tested organisms.

TABLE 2

| | | MIC, ppm | | | |
|---|---|---|---|---|---|
| | Strain | Jeffamine | Mergal | 1 to 1 | Synergy |
| Test Organism | Code | T403 | BIT20X | Mixture | Index |
| Escherichia coli | ATCC | 1500 | 94 | 47 | 0.27 |
| | #11229 | | | | |
| Bacillus sp. | Troy #JZ14 | 51 | 16 | 12 | 0.49 |
| Staphylococcus | ATCC #6538 | 3000 | 23 | 23 | 0.50 |
| aureus | | | | | |
| Enterobacter | ATCC | 1500 | 47 | 31 | 0.34 |
| aerogenes | #13048 | | | | |
| Pseudomonas | Troy | 750 | 250 | 78 | 0.21 |
| plecoglossicida | #JZ103 | | | | |
| Burkholderia | Troy #JZ2 | 3000 | 23 | 23 | 0.50 |
| cenocepacia | | | | | |
| Microbacterium | Troy #JZ13 | 563 | 16 | 12 | 0.39 |
| paraoxydans | | | | | |

### Example 3

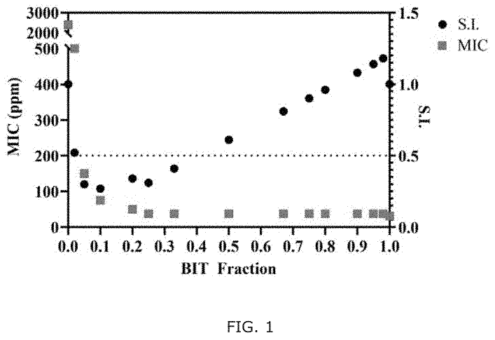

Synergy of Jeffamine T403 and Mergal BIT20X mixtures from 1:50 to 50:1 were tested against P. aeruginosa. Jeffamine T403 was diluted to 20% w/w before mixing with Mergal BIT20X at the indicated ratios. The results are plotted in FIG. 1. Jeffamine T403 and Mergal BIT20X are synergistic at ratios with excess T403. In FIG. 1, the x-axis indicates the fractional BIT level in the blend (1=100% BIT, 0=100% T403, 0.5=50% BIT, 50% T403, etc.), the left y-axis is the MIC against Pseudomonas aeruginosa (ATCC 10145), and the right y-axis is the calculated Synergy Index (SI). The dotted line indicates the synergy index cutoff as defined by EUCAST guidelines (SI<0.5). The MIC raw data is presented in Table 3; MIC values are reported on active concentration.

TABLE 3

| | | MIC, Pseudomonas aeruginosa | | | | |
|---|---|---|---|---|---|---|
| Fractional Amounts | | (ATCC #10145) | | | | |
| Mergal BIT20X | 20% T403 | Rep. 1 | Rep. 2 | Rep. 3 | Avg | Synergy Index |
| 0.02 | 0.98 | 600 | 600 | 300 | 500 | 0.52 |
| 0.98 | 0.02 | 38 | 38 | 38 | 38 | 1.18 |
| 0.05 | 0.95 | 150 | 150 | 150 | 150 | 0.30 |
| 0.95 | 0.05 | 38 | 38 | 38 | 38 | 1.14 |
| 0.9 | 0.1 | 38 | 38 | 38 | 38 | 1.08 |
| 0.1 | 0.9 | 75 | 75 | 75 | 75 | 0.27 |
| 0.2 | 0.8 | 75 | 38 | 38 | 50 | 0.34 |
| 0.8 | 0.2 | 38 | 38 | 38 | 38 | 0.96 |
| 1 | 0 | 19 | 38 | 38 | 31 | — |
| 0 | 1 | 2400 | 2400 | 2400 | 2400 | — |
| 0.5 | 0.5 | 38 | 38 | 38 | 38 | 0.61 |
| 0.33 | 0.67 | 38 | 38 | 38 | 38 | 0.41 |
| 0.67 | 0.33 | 38 | 38 | 38 | 38 | 0.81 |
| 0.25 | 0.75 | 38 | 38 | 38 | 38 | 0.31 |
| 0.75 | 0.25 | 38 | 38 | 38 | 38 | 0.90 |

### Example 4

Antibacterial performance of standard 10% BIT and boosted BIT product “1721-88” in one interior paint and two colorants were compared. The samples were inoculated over two weeks with an industrial inoculum. Samples free of growth 7 days following the second inoculation are considered well protected from growth. “1721-88” significantly outperformed pure BIT and enabled BIT to work at significantly lower concentrations; results are presented in Table 4. The “pass level” is defined as the minimum tested product level required to allow the formulation to be free of bacterial growth 7 days after a second ˜10⁷ bacterial challenge with a mixture of industrially important bacteria. The challenge raw data is available in Table 5.

TABLE 4

| | Minimum Pass Level | |
|---|---|---|
| | Through Two Challenges, | |
| | % w/w ([BIT], ppm) | |
| | Mergal | “1721-88” |
| Test Matrix | K10N | (T403:BIT) |
| Interior Paint | >0.40% | 0.10% (100) |
| #1 | (>400) | |
| Colorant (Red) | 0.30% | 0.015% (15) |
| | (300) | |
| Colorant (Black) | >0.40% | 0.20% (200) |
| | (>400) | |

TABLE 5

| | | Days After Challenge | | | | | |
|---|---|---|---|---|---|---|---|
| | | Challenge #1 | | | Challenge #2 | | |
| Description | [BIT], ppm | 1 | 2 | 7 | 1 | 2 | 7 |
| Interior Paint #1 | 0 | 4 | 4 | 4 | 4 | 4 | 4 |
| +0.015% “1721-88” | 15 | 4 | 3 | 3 | 4 | 4 | 4 |
| +0.05% “1721-88” | 50 | 4 | 3 | 2 | 4 | 4 | 2 |
| +0.10% “1721-88” | 100 | 4 | 3 | 0 | 4 | 3 | 0 |
| +0.20% “1721-88” | 200 | 4 | 3 | 0 | 3 | 3 | 0 |
| +0.30% “1721-88” | 300 | 3 | 2 | 0 | 3 | 3 | 0 |
| +0.40% “1721-88” | 400 | 3 | 2 | 0 | 3 | 3 | 0 |
| +0.015% Mergal K10N | 15 | 4 | 3 | 3 | 4 | 4 | 4 |
| +0.05% Mergal K10N | 50 | 4 | 3 | 3 | 4 | 4 | 3 |
| +0.10% Mergal K10N | 100 | 4 | 3 | 3 | 4 | 4 | 3 |
| +0.20% Mergal K10N | 200 | 4 | 3 | 3 | 4 | 3 | 3 |
| +0.30% Mergal K10N | 300 | 4 | 3 | 1 | 4 | 3 | 2 |
| +0.40% Mergal K10N | 400 | 3 | 3 | 0 | 4 | 3 | 1 |
| Colorant (Red) | 0 | 4 | 3 | 3 | 4 | 3 | 3 |
| +0.015% “1721-88” | 15 | 3 | 3 | 0 | 4 | 3 | 0 |
| +0.05% “1721-88” | 50 | 3 | 3 | 0 | 3 | 3 | 0 |
| +0.10% “1721-88” | 100 | 3 | 3 | 0 | 3 | 3 | 0 |
| +0.20% “1721-88” | 200 | 3 | 0 | 0 | 3 | 3 | 0 |
| +0.30% “1721-88” | 300 | 3 | 0 | 0 | 3 | 3 | 0 |
| +0.40% “1721-88” | 400 | 3 | 0 | 0 | 3 | 2 | 0 |
| +0.015% Mergal K10N | 15 | 3 | 3 | 3 | 3 | 3 | 3 |
| +0.05% Mergal K10N | 50 | 3 | 3 | 2 | 3 | 3 | 2 |
| +0.10% Mergal K10N | 100 | 3 | 3 | 1 | 3 | 3 | 2 |
| +0.20% Mergal K10N | 200 | 3 | 3 | 0 | 3 | 3 | 1 |
| +0.30% Mergal K10N | 300 | 3 | 3 | 0 | 3 | 3 | 0 |
| +0.40% Mergal K10N | 400 | 3 | 3 | 0 | 3 | 3 | 0 |
| Colorant (Black) | 0 | 4 | 3 | 3 | 4 | 4 | 4 |
| +0.015% “1721-88” | 15 | 3 | 3 | 3 | 4 | 4 | 4 |
| +0.05% “1721-88” | 50 | 3 | 3 | 3 | 3 | 3 | 3 |
| +0.10% “1721-88” | 100 | 3 | 0 | 1 | 3 | 3 | 3 |
| +0.20% “1721-88” | 200 | 3 | 0 | 0 | 3 | 2 | 0 |
| +0.30% “1721-88” | 300 | 3 | 0 | 0 | 3 | 1 | 0 |
| +0.40% “1721-88” | 400 | 3 | 0 | 0 | 3 | 0 | 0 |
| +0.015% Mergal K10N | 15 | 3 | 3 | 3 | 4 | 4 | 4 |
| +0.05% Mergal K10N | 50 | 3 | 3 | 3 | 4 | 4 | 4 |
| +0.10% Mergal K10N | 100 | 3 | 3 | 3 | 3 | 3 | 3 |
| +0.20% Mergal K10N | 200 | 3 | 3 | 3 | 3 | 3 | 3 |
| +0.30% Mergal K10N | 300 | 3 | 3 | 3 | 3 | 3 | 3 |
| +0.40% Mergal K10N | 400 | 3 | 3 | 3 | 3 | 3 | 3 |

What is claimed is:

1. A preservative composition comprising (a) at least one isothiazolin-3-one and (b) at least one compound of the formula I: 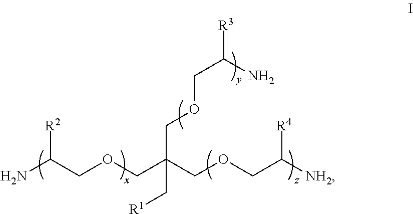
wherein R¹ is H or C₁ to C₉ alkyl, R², R³, and R⁴ are independently H or CH₃, and x, y, and z are independently 1 to 10, and wherein (a) and (b) are present in a weight ratio (a):(b) of from 1:200 to 2:3.

2. The composition of claim 1, wherein (a) and (b) are present in a weight ratio (a):(b) of from 1:50 to 1:2.

3. The composition of claim 2, wherein (a) and (b) are present in a weight ratio (a):(b) of from 1:25 to 25:75.

4. The composition of claim 1, wherein the isothiazolin-3-one is selected from the group consisting of 1,2-benzisothiazolin-3-one, N-(n-butyl)-1,2-benzisothiazolin-3-one, 4,5-dichloro-2-n-octyl-4-isothiazolin-3-one, 2-methyl-4-isothiazolin-3-one, 5-chloro-2-methyl-4-isothiazolin-3-one, 2-methyl-4-isothiazolin-3-one, and mixtures thereof.

5. A preservative concentrate, comprising the preservative composition of claim 1, wherein the concentrate comprises 1 to 45% w/w of (a), based on the weight of the concentrate.

6. The preservative concentrate of claim 5, further comprising one or more co-biocides selected from the group consisting of fungicides, bactericides, and algaecides, wherein the concentrate comprises 1 to 50% w/w of the co-biocide, based on the weight of the concentrate.

7. An industrial material comprising a preservative, the preservative comprising a combination of (a) at least one isothiazolin-3-one and (b) at least one compound of the formula I: 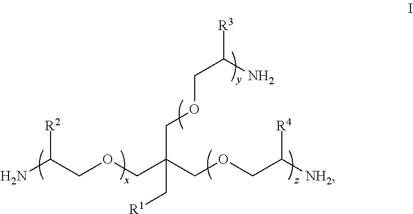
wherein R¹ is H or C₁ to C₉ alkyl, R², R³, and R⁴ are independently H or CH₃, and x, y, and z are independently 1 to 10, wherein (a) and (b) are present in a weight ratio (a):(b) of from 1:200 to 2:3, and wherein (a) is present in the industrial material in a total amount of less than or equal to about 500 ppm.

8. The industrial material of claim 7, wherein (a) is present in the composition in a total amount of about 5 ppm to about 50 ppm.

9. The industrial material of claim 8, wherein (a) is present in the composition in a total amount of about 5 ppm to about 30 ppm.

10. The industrial material of claim 9, wherein (a) is present in the composition in a total amount of about 10 ppm to about 25 ppm.

11. The industrial material of claim 7, wherein (a) is present in the composition in a total amount of less than about 50 ppm.

12. The industrial material of claim 11, wherein (a) is present in the composition in a total amount of less than about 25 ppm.

13. The industrial material of claim 7, comprising an emulsion of a polymer selected from the group consisting of acrylates, substituted (meth)acrylates, styrene/butadiene, ethylene/vinyl acetate, polyvinyl acetate, styrene/butadiene/N-methylol acrylamide, nitriles, and mixtures or copolymers thereof.

14. The industrial material of claim 7, wherein the isothiazolin-3-one is selected from the group consisting of 1,2-benzisothiazolin-3-one, N-(n-butyl)-1,2-benzisothiazolin-3-one, 4,5-dichloro-2-n-octyl-4-isothiazolin-3-one, 2-methyl-4-isothiazolin-3-one, 5-chloro-2-methyl-4-isothiazolin-3-one, 2-methyl-4-isothiazolin-3-one, and mixtures thereof.

15. The industrial material of claim 7, further comprising one or more co-biocides selected from the group consisting of fungicides, bactericides, and algaecides, wherein the co-biocide is present in said composition in an amount of from about 0.001 to about 1.0% w/w based on the total weight of said composition.

16. The industrial material of claim 7, selected from the group consisting of paints, colorants, coatings, plasters, adhesives, sealants, caulks, mineral slurries, pigments, pigment slurries, concrete, polymer emulsions, polymer dispersions, inks, sizes, agricultural pesticide formulations, household coating products, personal care products, cooling lubricants, heat transfer liquids, metal working fluids, oil concentrates, varnishes, sealing compositions, leather auxiliaries, paper coating agents, and cosmetics.

17. The composition of claim 1, wherein x, y, and z are independently 1 to 5.

18. The composition of claim 17, wherein x, y, and z are independently 1, 2, or 3.

19. The composition of claim 18, wherein x+y+z=5 or 6.

20. The composition of claim 2, wherein (a) and (b) are present in a weight ratio (a):(b) of from 5:95 to 33:67.

21. The composition of claim 2, wherein (a) and (b) are present in a weight ratio (a):(b) of from 1:40 to 1:2.

22. The composition of claim 21, wherein (a) and (b) are present in a weight ratio (a):(b) of from 1:30 to 1:2.

23. The composition of claim 22, wherein (a) and (b) are present in a weight ratio (a):(b) of from 1:20 to 1:2.

24. The composition of claim 23, wherein (a) and (b) are present in a weight ratio (a):(b) of from 1:20 to 1:3.

25. A method of preserving an industrial material in the wet state, comprising adding to the industrial material an effective amount of the preservative composition of claim 1.

26. The method of claim 25, wherein the industrial material is selected from the group consisting of paints, coatings, plasters, adhesives, sealants, caulks, mineral slurries, pigments, pigment slurries, concrete, polymer emulsions, polymer dispersions, inks, sizes, agricultural pesticide formulations, household cleaning products, personal care products, cooling lubricants, heat transfer liquids, metal working fluids, oil concentrates, varnishes, sealing compositions, leather auxiliaries, paper coating agents, cosmetics and preservatives for such industrial materials.

27. The method of claim 25, comprising inhibiting or preventing growth of microorganisms in the industrial material.

28. The method of claim 27, wherein the microorganisms are selected from the group consisting of bacteria, fungi, yeasts, algae, slimes, and mixtures thereof.

29. The industrial material of claim 7, wherein (a) is present in the material in a total amount of about 5 ppm to about 50 ppm.

30. The industrial material of claim 29, wherein the BIT is present in the material in a total amount of about 5 ppm to about 30 ppm.

31. The industrial material of claim 30, wherein the BIT is present in the material in a total amount of about 10 ppm to about 25 ppm.

32. The industrial material of claim 7, wherein the BIT is present in the material in a total amount of less than about 50 ppm.

33. The industrial material of claim 32, wherein the BIT is present in the material in a total amount of less than about 25 ppm.
